(19) United States
(12) Patent Application Publication
(10) Pub. No.: US 2024/0221352 A1
(43) Pub. Date: Jul. 4, 2024

(54) IMAGE PROCESSING DEVICE

(71) Applicant: FANUC CORPORATION, Yamanashi (JP)

(72) Inventors: Shoutarou OGURA, Yamanashi (JP); Yuta NAMIKI, Yamanashi (JP)

(73) Assignee: FANUC CORPORATION, Yamanashi (JP)

(21) Appl. No.: 18/555,884

(22) PCT Filed: May 13, 2021
(86) PCT No.: PCT/JP2021/018278

§ 371 Date: Oct. 18, 2023

(51) Int. Cl. G06V 10/74; G06V 10/56; G06V 10/60

(52) U.S. Cl. CPC G06V 10/761; G06V 10/56; G06V 10/60; G06V 2201/07

(57) ABSTRACT

An image processing device according to one aspect of the present disclosure for which detection parameters can easily be set comprises: a model storage unit that stores a model pattern; a characteristic point extraction unit that extracts characteristic points from a photographed image; an original matching degree calculation unit that calculates the degree of matching between the model pattern and arrangement of the characteristic points; an object detection unit that detects an object in the photographed image by comparing the degree of matching with a detection threshold value; a parameter setting unit that sets detection parameters including at least the detection threshold value; a detection information storage unit that stores, for characteristic points of the object detected by the target object detection unit, detection information including at least the positions of the characteristic points; and a simple matching degree calculation unit that calculates, if the detection parameters are changed, the degree of matching based on the changed detection parameters and the detection information stored in the detection information storage unit.

### TECHNICAL FIELD

The present invention relates to an image processing device.

### BACKGROUND ART

For example, in a system for picking up randomly supplied target objects, an image processing technique for specifying the positions of target objects through analyzing an image captured by an imaging device (camera) is widely used. Generally, in such a image processing technique, characteristic points in the captured image are extracted, and it is determined that the target objects are present in the image when the matching degree is high between the arrangement pattern of a plurality of extracted characteristic points and a model pattern stored in advance, i.e., when the numerical value of the matching degree is equal to or more than a threshold.

When the threshold of the matching degree is too low, a false detection which erroneously detects objects other than the target objects intended to be detected occurs. On the other hand, when the threshold of the matching degree is too high, the target objects intended to be detected are undetectable as target objects. Therefore, it is necessary for the user to set the threshold of the matching degree so as to reduce the false detection or prevent from being undetectable while confirming the detection results in a plurality of captured images.

Luminance gradient of the captured image can vary with ambient brightness and other factors. Therefore, it is proposed to set the threshold of the luminance gradient through statistically processing the distribution of the luminance gradient in the captured image and extracting characteristic points based on an average value and a standard deviation thereof (see Patent Document 1).
Patent Document 1: Japanese Unexamined Patent Application, Publication No. 2017-91079

### DISCLOSURE OF THE INVENTION

### Problems to be Solved by the Invention

In a case of setting a plurality of detection parameters such as a threshold of the matching degree and a threshold of luminance gradient, the optimization of these parameters is a very complicated, cumbersome task. Furthermore, when the extraction threshold of the characteristic points is determined statistically, the decision of the user required in a setting operation can be made easily. However, when the detection parameter is changed, it requires a substantial time for setting the detection parameter, since it is necessary to conduct the statistical processing again, extract the characteristic points again, and then calculate the matching degree. Therefore, it is desired to provide a technique capable of easily setting a detection parameter of the image processing device.

### Means for Solving the Problems

An image processing device according to an aspect of the present disclosure is directed to an image processing device for detecting a target object in a captured image of an imaging device, the image processing device including: a model storage unit that stores a model pattern; a characteristic point extraction unit that extracts a characteristic point from the captured image; an original matching degree calculation unit that calculates a matching degree between the model pattern and an arrangement of the characteristic point; a target object detection unit that detects the target object in the captured image based on a comparison between the matching degree and a detection threshold; a parameter setting unit that sets a detection parameter including at least the detection threshold; a detection information storage unit that stores detection information including at least a position of the characteristic point with respect to the characteristic point of the target object detected by the target object detection unit; and a simple matching degree calculation unit that calculates, when the detection parameter has been changed, the matching degree based on the changed detection parameter and the detection information stored in the detection information storage unit.

### Effects of the Invention

In accordance with the present disclosure, it is possible to provide an image processing device capable of setting a detection parameter easily.

### BRIEF DESCRIPTION OF THE DRAWINGS

FIG. 1 is a block diagram showing the arrangement of an image processing device according to a first embodiment of the present invention;

FIG. 2 is a block diagram showing the arrangement of an image processing device according to a second embodiment of the present invention; and

FIG. 3 illustrates a diagram showing a display screen of a user interface unit of the image processing device in FIG. 2.

### PREFERRED MODE FOR CARRYING OUT THE INVENTION

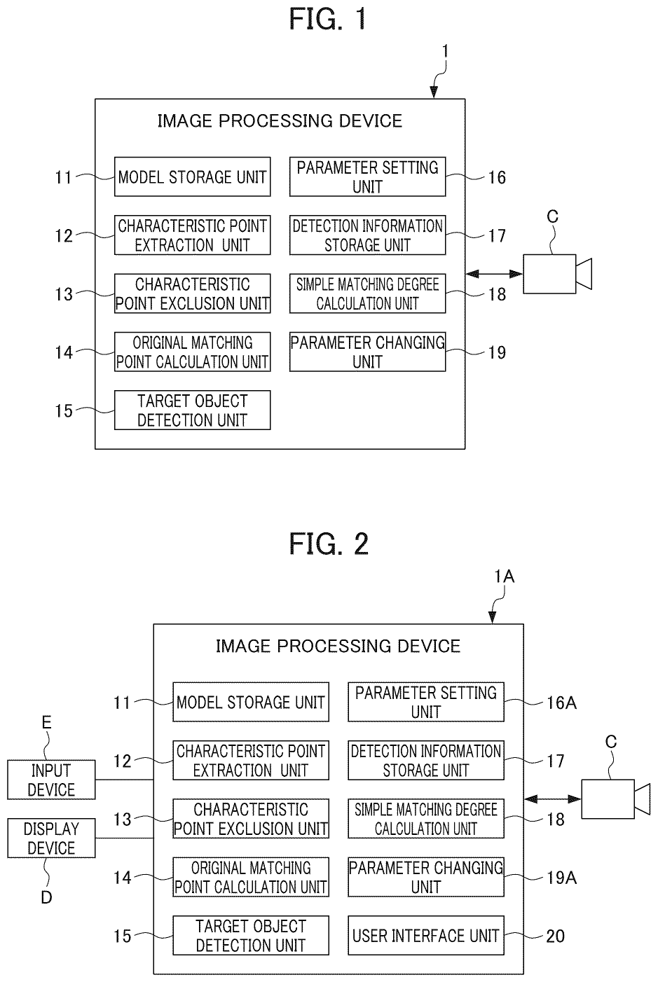

Embodiments of the present invention will now be described with reference to the attached drawings. FIG. 1 is a block diagram showing the arrangement of an image processing device 1 according to a first embodiment of the present invention.

The image processing device 1 acquires data of an image captured by an imaging device C and detects a target object in the captured image. The imaging device C acquires an image of a subject within a predetermined field of view thereof. The imaging device C may be a visual sensor for acquiring visible images or may be an infrared image sensor, a distance image sensor, or a sensor for acquiring a point cloud image.

The image processing device 1 includes a model storage unit 11, a characteristic point extraction unit 12, a characteristic point exclusion unit 13, an original matching degree calculation unit 14, a target object detection unit 15, a parameter setting unit 16, a detection information storage unit 17, a simple matching degree calculation unit 18, and a parameter changing unit 19.

The image processing device 1 can be realized by running an appropriate program through one or a plurality of computer devices including memory, a CPU, and an input-output (I/O) interface. Each component of the image processing device 1 described above is a category of the functions of the image processing system 1, and does not have to be clearly distinguishable in terms of physical and programmatic configuration.

The model storage unit 11 stores a model pattern obtained by converting the contour of the target object to data. The model pattern may, for example, be generated theoretically from shape data of the target object, or may be generated from contour data of the target object specified in the image actually captured from the target object, or from coordinates of the characteristic points.

The characteristic point extraction unit 12 extracts, from the captured image, characteristic points which change discontinuously between adjacent image regions, and thus, may form a contour of the target object. More specifically, the characteristic point extraction unit 12 is configured to extract, as the characteristic points, points in which attribute values of pixels are equal to or more than an extraction threshold or points in which the attribute values of the pixels fall within an extraction range. The extraction threshold and the extraction range are set by the parameter setting unit 16. It is desirable for the attribute value to identify the characteristic points to include at least one selected from the color, the luminance, and the magnitude and the direction of the luminance gradient of the characteristic points. It is to be noted that the luminance gradient indicates the difference in luminance between adjacent pixels or unit regions, i.e., the rate of change of luminance relative to positions, and the direction of the luminance gradient indicates the direction of maximum luminance change between adjacent pixels or unit regions. By using these attribute values as indicators, it is possible to extract points in the image that are likely to be a contour of some object or pattern. In particular, points with large luminance gradients are likely to be object contours.

The characteristic point exclusion unit 13 excludes characteristic points whose distance to a model pattern exceed the distance threshold from the calculation target in the original matching degree calculation unit 14. With such a configuration, it is possible to improve the detection accuracy of the target object by excluding noises which do not form the outline of the target object clearly.

The original matching degree calculation unit 14 calculates the matching degree between the model pattern and the arrangement of the characteristic points. As a specific example, the model pattern is arranged so that the sum of the squares of the distances or distances to the model pattern of all the characteristic points except those excluded by the characteristic point exclusion unit 13 is the smallest, and the degree to which the characteristic points match the model pattern is quantified. The method for calculating the matching degree may be the same as those used in the conventional image processing devices.

The target object detection unit 15 detects the target object in the captured image based on the comparison between the matching degree calculated by the original matching degree calculation unit 14 and the detection threshold set by the parameter setting unit. In other words, the target object detection unit 15 determines that the characteristic points correspond to the contour of the target object when the matching degree is equal to or more than the detection threshold, and determines that any target object is undetectable when the matching degree is below the detection threshold.

The parameter setting unit 16 sets a detection parameter including the detection threshold to be employed at least by the target object detection unit 15. In other words, the parameter setting unit 16 performs initial setting of the detection parameter, and stores a value of the detection parameter initially set or a value of the detection parameter that has been changed by the parameter changing unit 19 after the initial setting. The parameter setting unit 16 of the present embodiment sets not only the distance threshold, but also the extraction threshold to be employed by the characteristic point extraction unit 12, and the detection threshold to be employed by the target object detection unit 15. The parameter setting unit 16 may set the initialized value of the detection parameter to a predetermined value, or set the initial value to a value to be inputted by the user after the user input.

The initial value of the extraction threshold to be set by the parameter setting unit 16 is preferably set to be sufficiently low or set to a value that covers a broad range, i.e., a value that extracts more characteristic points than the appropriate number of characteristic points. With such a configuration, it is possible for the detection information storage unit 17 to allow the sufficient amount of pieces of detection information of the characteristic points to be stored, and it is possible for the simple matching degree calculation unit 18 to calculate the matching degree after the change of the detection parameter relatively accurately. Furthermore, the parameter setting unit 16 may cause the characteristic point extraction unit 12 to extract the characteristic points using the captured image, and search for a value at which a certain number of characteristic points are extracted to set the value as an initial value for the extraction threshold.

The detection information storage unit 17 stores the detection information including at least the position of the characteristic point with respect to the characteristic points of the target object extracted by the characteristic point extraction unit 12. In order to allow the simple matching degree calculation unit 18 to calculate again the matching degree according to the change of the extraction threshold, the detection information stored in the detection information storage unit 17 preferably further includes the attribute value of the characteristic point to be compared with the extraction threshold.

When the detection parameter has been changed by the parameter changing unit 19, the simple matching degree calculation unit 18 calculates the matching degree based on the changed detection parameter and the detection information stored in the detection information storage unit 17. With such a configuration, it is possible to easily determine whether the change of the detection parameter is appropriate since the simple matching degree calculation unit 18 calculates the matching degree again when the detection parameter has been changed. Furthermore, since it is possible to confirm the matching degree after the change of the detection parameter without extracting characteristic points of high computational load by the simple matching degree calculation unit 18 calculating the matching degree from the detection information, it is possible to optimize the detection parameter in a short time.

The parameter changing unit 19 changes the detection parameter so as to increase the matching degree calculated by the simple matching degree calculation unit 18 based on the detected information.

In other words, the parameter changing unit 19 optimizes the detection parameter automatically so that non-detection becomes seldom.

More specifically, the parameter changing unit 19 is configured to change the detection parameter temporarily and causes the simple matching degree calculation unit 18 to calculate the matching degree again to confirm a value of the detection parameter having a sufficiently high matching degree, thereby determining the value of the detection parameter. The parameter changing unit 19 may be configured to change the detection parameter to a plurality of preset values to confirm the matching degree, and ultimately choose the value having the maximum matching degree. Furthermore, the parameter changing unit 19 may be configured to search for the values of detection parameters that can sufficiently increase the degree of agreement based on any algorithm, such as the binary search method, the mountain climbing method, etc.

As described above, in the image processing device 1, the parameter changing unit 19 employs the simple matching degree calculation unit 18 calculating the matching degree again based on the detection information stored in the detection information storage unit 17, and optimizes the detection parameter without repetitively extracting the characteristic points performed by the characteristic point extraction unit 12, which requires large computational load, whereby it is possible to set the detection parameter to an optimized value promptly.

FIG. 2 is a block diagram showing the configuration of an image processing device 1A according to the second embodiment of the present invention. For the image processing device 1A in FIG. 2, the same reference numerals may be used for components similar to those of the image processing unit 1 in FIG. 1, and redundant explanations may be omitted.

The image processing device 1A acquires data of an image captured by the imaging device C and detects a target object in the captured image. Furthermore, the image processing device 1A receives an input through an input device E from a user, and displays information to the user through a display device D. In the image processing device 1A of the present embodiment, it is possible for the user to set a value of the detection parameter proactively.

As the input device E, one or more devices such as a keyboard or a mouse can be used. As the display device D, any image displaying device having an ability to display the image captured by the imaging device C such as a CRT, a liquid crystal panel, or an organic EL panel can be used.

The image processing device 1A includes a model storage unit 11, a characteristic point extraction unit 12, a characteristic point exclusion unit 13, an original matching degree calculation unit 14, a target object detection unit 15, a parameter setting unit 16A, a detection information storage unit 17, a simple matching degree calculation unit 18, a parameter changing unit 19A, and a user interface unit 20.

The parameter setting unit 16A sets a detection parameter in accordance with an input of the user through the user interface unit 20. It is to be noted that the parameter setting unit 16A may be configured to set an initial value of the detection parameter based on a preset initial setting value or a setting value in the past.

The parameter changing unit 19A changes the detection parameter in accordance with the input of the user through the user interface unit 20.

The user interface unit 20 displays the image captured by the imaging device C, the matching degree calculated by the original matching degree calculation unit 14, a detection result by the target object detection unit 15, the detection parameter set in the parameter setting unit 16A, and the matching degree calculated by the simple matching degree calculation unit 18 on the display device D as necessary in a sole or combined manner. Furthermore, the user interface unit 20 displays, together with those mentioned above, an image of a textbox, etc., that prompts the user to input a setting value of the detection parameter through the input device E on the display device D.

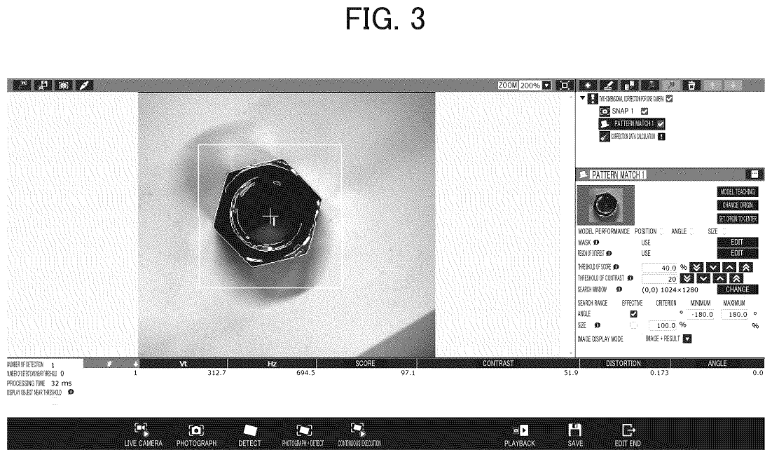

FIG. 3 illustrates an example of a display screen of the display device D performed by the user interface unit 20. The display screen includes an area for displaying the captured image (upper left), an area for performing display for the user to set the detection parameter (middle right), and an area for displaying the characteristic point extraction unit 12, the original matching degree calculation unit 14, and the calculation result by the simple matching degree calculation unit 18 (bottom). In the display screen, the matching degree is displayed as “score”, the detection threshold is displayed as “threshold of score”, and the detection threshold of the luminance gradient is displayed as “threshold of contrast”. In the captured image, the characteristic points extracted by the characteristic point extraction unit 12 are color-coded or distinguished by color, and overlaid with those excluded by the characteristic point exclusion unit 13 and those not excluded.

In the image processing device 1A, when the user changes the detection parameter on the screen, the simple matching degree calculation unit 18 calculates again the matching degree based on the detection information stored in the detection information storage unit 17 without extracting the characteristic points by the characteristic point extraction unit 12. Therefore, the color of the characteristic points and the value of the matching degree (score) vary without any time lag. Therefore, it is possible for the user to confirm not only the numerical value of the matching degree, but also the corresponding relationship between the captured image and the characteristic points employed for the matching degree, thereby setting a more appropriate detection parameter.

Although embodiments of the present disclosure have been described, the present invention may not be limited to the embodiment as described above. The advantageous effects described in the above embodiments are only an enumeration of those most preferred in the present invention, and the advantageous effects of the present invention are not to be limited to those described in the above embodiment.

As an example, in the image processing device in accordance with the present disclosure, the parameter changing unit may include both the function of changing the detection parameter automatically as in the first embodiment and the function of changing the detection parameter in accordance with the user input as in the second embodiment in a switchable manner.

### EXPLANATION OF REFERENCE NUMERALS

1, 1A image processing device
11 model storage unit
12 characteristic point extraction unit
13 characteristic point exclusion unit
14 original matching degree calculation unit
15 target object detection unit
16, 16A parameter setting unit
17 detection information storage unit
18 simple matching degree calculation unit
19, 19A parameter changing unit
20 user interface unit
C imaging device
D display device
E input device

1. An image processing device that detects a target object in a captured image of an imaging device, the image processing device comprising:
a model storage unit that stores a model pattern;
a characteristic point extraction unit that extracts a characteristic point from the captured image;
an original matching degree calculation unit that calculates a matching degree between the model pattern and an arrangement of the characteristic point;
a target object detection unit that detects the target object in the captured image based on a comparison between the matching degree and a detection threshold;
a parameter setting unit that sets a detection parameter including at least the detection threshold;
a detection information storage unit that stores detection information including at least a position of the characteristic point with respect to the characteristic point of the target object detected by the target object detection unit; and
a simple matching degree calculation unit that calculates, when the detection parameter has been changed, the matching degree based on the detection parameter changed and the detection information stored in the detection information storage unit.

2. The image processing device according to claim 1, wherein
the characteristic point extraction unit extracts, as the characteristic point, a point in which an attribute value is equal to or more than an extraction threshold,
the detection parameter to be set by the parameter setting unit includes the extraction threshold, and
the detection information stored in the detection information storage unit includes the attribute value.

3. The image processing device according to claim 2, wherein the attribute value includes at least any one selected from color, luminance, magnitude of a luminance gradient, and direction of the luminance gradient of the characteristic point.

4. The image processing device according to claim 1, further comprising a parameter changing unit that changes the detection parameter to increase the matching degree calculated by the simple matching degree calculation unit based on the detection information.

5. The image processing device according to claim 1, further comprising a user interface unit that displays the matching degree calculated by the simple matching degree calculation unit.
